(19) United States
(12) Patent Application Publication
(10) Pub. No.: US 2013/0301044 A1
(43) Pub. Date: Nov. 14, 2013

(54) DEVICE FOR IDENTIFYING BIOTIC PARTICLES

(71) Applicants: Alois Friedberger, Oberpframmern (DE); Jürgen Popp, Jena (DE); Petra Rösch, Jena (DE); Markus Lankers, Schoneiche (DE)

(72) Inventors: Alois Friedberger, Oberpframmern (DE); Jürgen Popp, Jena (DE); Petra Rösch, Jena (DE); Markus Lankers, Schoneiche (DE)

(73) Assignee: EADS DEUTSCHLAND GMBH, Ottobrunn (DE)

(21) Appl. No.: 13/992,087

(22) PCT Filed: Dec. 2, 2011
(86) PCT No.: PCT/DE11/02066

§ 371 Date: Aug. 2, 2013

(30) Foreign Application Priority Data
Dec. 8, 2010 (DE) 10 2010 053 749.7

(51) Int. Cl. G01J 3/44

(52) U.S. Cl. CPC G01J 3/44
USPC 356/301

(57) ABSTRACT

The invention relates to a device (100) for identifying biotic particles in a medium to be analyzed, comprising a measuring cell (104), through which the medium to be analyzed can flow and in which the identification of the biotic particles is carried out by means of Raman spectroscopy, and a feed (102) by means of which the medium to be analyzed can be fed to the measuring cell (104). The device (100) according to the invention is characterized in that the feed (102) comprises at least one sensor (101) with which the presence of biotic particles in the medium flowing through the feed (102) can be ascertained. The feed (102) has a controllable bypass valve (103) downstream of the sensor (101), and the medium can be selectively fed to the measuring cell (104) or to a bypass channel (106) via said bypass valve. First control means (108) are provided by means of which the bypass valve (103) can be controlled such that the medium is only fed to the measuring cell (104) in order to identify the biotic particles if biotic particles were detected in the medium by the sensor (101).

The invention relates to a device for identifying biotic particles in a gaseous or liquid medium.

Devices and methods for identifying biotic particles in liquid media (e.g., in potable water) or in gaseous media (e.g., in the ambient air) are known and are furthermore subject matter of current research. The goal of the research and further development is to make the demonstration methods for biotic particles more selective, more reliable and more rapid and to make available correspondingly reliable and compact devices for the automatic identification of biotic particles.

The known devices and methods are used today, for example, in the pharmaceutical industry, the chemical, food, photovoltaic, automobile or semiconductor industries but also in medical environments such as in clinics, etc. in order, for example, to monitor the air quality in so-called clean rooms. A clean room is a room in which the concentration of airborne abiotic particles (e.g., dusts) and biotic particles (microorganisms such as: bacteria, funguses, algae, protozoa, viruses) is kept as low as possible. The clean room conditions to be maintained are correspondingly set in accordance with the use or the task. The methods and devices known in the prior art make it possible to determine in particular biotic particles not only quantitatively but also qualitatively, i.e., to unambiguously identify microorganisms contained in a gaseous or liquid medium. The identification of the biotic particles preferably takes place by the use of Raman spectroscopy [e.g., Raman, FT Raman, NIR FT Raman, resonance Raman, UV resonance Raman, SERS (Engl. for “Surface Enhanced Raman Spectroscopy”), SERRS (Engl. for “Surface Enhanced Resonance Raman Spectroscopy”)].

For example, the publication DE 10 2004 008 762 B4 discloses such a method and such a device for the detection and identification of biotic particles (bioparticles). The described device comprises a filter on which biotic and abiotic particles are separated, for example, from a current of air. The device furthermore comprises a detection unit for determining the position and the form factors of individual biotic particles separated on the filter and for differentiating between biotic and abiotic particles. Finally, the device comprises an identification device with which Raman spectra of the separated particles can be determined, and a data processing device with which a measured Raman spectrum can be associated with each detected particle and this information can be stored and/or further processed for identifying the detected particles.

The invention has the task of indicating a device that allows a reliable and rapid identification of biotic particles in a medium, whereby the maintenance expense is reduced and the reliability increased in contrast to the state of the art.

The invention results from the features of the independent claims. Advantageous further developments and embodiments are subject matter of the dependent claims. Further features, possibilities of use and advantages of the invention result from the following description as well as from the explanation of a preferred exemplary embodiment of the invention shown in the FIGURE.

The problem is solved by a device for identifying biotic particles in a medium to be analyzed, with a measuring cell through which the medium to be analyzed can flow and in which the identification of the biotic particles takes place by Raman spectroscopy, and with a feed with which the medium to be analyzed can be fed to the measuring cell, whereby the feed comprises at least one sensor with which the presence of biotic particles in the medium flowing through the feed can be detected, which feed comprises a controllable bypass valve downstream from the sensor via which valve the medium can be selectively fed to the measuring cell or to a bypass conduit, and whereby a first control means is present with which the bypass valve can be controlled in such a manner that the medium is only fed to the measuring cell for identifying the biotic particles if biotic particles were recognized by the sensor in the medium.

The device in accordance with the invention is based on the idea that the medium (gaseous or liquid) to be analyzed is only to be fed to the measuring cell if the presence of biotic particles was detected in the medium flowing through the feed by the sensor arranged in the feed. On the other hand, if no biotic particles are recognized by the sensor in the medium to be analyzed, the medium is fed in accordance with the invention instead of to the measuring cell to a bypass conduit through which the medium passes, e.g., into the environment. The corresponding switching of the medium current takes place by the bypass valve connected in front of the measuring cell, which valve is controlled by the first control means. The bypass valve is preferably designed in such a manner that the switching time between the two valve states (conducting the entire medium flow further to the measuring cell or to the bypass conduit) is a short as possible so that in the ideal case the medium current is digitally fed either to the measuring cell or to the bypass conduit.

Thus, in the device in accordance with the invention contamination effects in the measuring cell are minimized, the time that the measuring cell is used between two cleaning cycles is increased and the measuring accuracy and reliability of the device is improved.

The term “bypass valve” denotes in the present instance a device with an input conduit E and two output conduits A1 and A2, whereby the medium to be analyzed and flowing in through the input conduit E flows selectively out, i.e., can be switched, either through the output conduit A1 or through the output conduit A2. Therefore, in the present instance one output conduit of the bypass valve is connected to the measuring cell and the other output conduit to the bypass conduit. Such a bypass valve can be produced, e.g., with methods of microsystem technology, whereby the switching of the output conduits takes place with microactors. In order to ensure a given throughput of the medium to be analyzed, even several feeds designed in accordance with the invention can be arranged in parallel and connected to the measuring cell.

The concept “bypass conduit” is widely understood in the present context. It can be a pipeline, a flow conduit or, however, only an exit opening.

The concept “available” stands in the present case as a synonym for “present”. Therefore, only the presence of biotic particles in the medium to be analyzed and detected by the sensor is determined by the sensor arranged in the feed. An identification, i.e., an unambiguous recognition (type, species) of individual biotic particles based on the sensor signal does not take place.

The sensor used is preferably an optical sensor with which at least one optical quality of the medium to be analyzed such as, for example, the quality of fluorescence or of absorption or of transmission can be determined. The sensor is appropriately calibrated so that the presence of biotic particles is recognized in a sufficiently unambiguous manner. To this end preferably more than one optical quality is evaluated or several sensors can also be used that detect the optical or other qualities of the medium to be analyzed. Thus, a preferred further development of the device in accordance with the invention is distinguished in that the one or another sensor is an optical sensor with which a particle size and/or a particle density in the medium of present particles to be analyzed can be determined. This allows, for example a differentiation of abiotic and biotic particles. Furthermore, the sensor is preferably adjusted and designed in such a manner that it detects the entire cross section of the flow of the medium flowing through the feed. It can be ensured in this manner that all biotic particles present in the medium can be detected by the sensor.

The evaluation of the sensor signals must take place sufficiently rapidly depending on the flow rate of the medium through the feed so that the control means can switch the bypass valve connected in after the sensor in time before a medium volume scanned by the sensor reaches the bypass valve. A switching of the bypass valve at the right time can be ensured by an appropriate coordination of the flow rate of the medium through the feed, of the time required for the evaluation of the sensor measuring and of the delay of the switching time of the bypass valve so that the medium to be analyzed only passes into the measuring cell if biotic particles are present in the medium to be analyzed.

According to an advantageous further development the feed between the bypass valve and the measuring cell or the measuring cell itself comprises a first means with which biotic particles contained in the medium to be analyzed can be inactivated. The concept “inactivation” is also to be understood in the present case as meaning “to kill” or “render harmless”. In particular, germs dangerous to one's health can be killed by the inactivation. The inactivation can be used in a general manner, thus, even if germs dangerous to one's health are not to be expected, in order to work in a general manner with inactive biotic particles when evaluating the Raman spectra obtained in the measuring cell. This has the advantage that when evaluating the spectra for the identification of individual biotic particles non-parallel multiple comparison databanks, i.e., for biotic, active particles and biotic, inactive particles must be used.

The first means for the inactivation of biotic particles preferably comprises at least one electromagnetic and/or an acoustic radiation source and/or a particle radiation source. As an alternative or in addition the first means can be designed and adjusted to emit a substance that inactivates biotic particles into the medium to be analyzed. Appropriate substances, electromagnetic, acoustic or particle radiation sources are known to the person skilled in the art.

Furthermore, the measuring cell preferably comprises at least one sensor means with which the form, and/or the size, and/or the nature of the surface and/or the color and/or elastic light-scattering data of one or more biotic particles can be detected. This sensor data can be evaluated e.g., by pattern recognition methods and facilitate and/or make possible a differentiation of abiotic and biotic particles. In addition, the detected, different measured data can be correlated with each other, which makes possible an improved classification and/or identification of the biotic particles.

Another preferred further development of the device in accordance with the invention is distinguished in that the measuring cell comprises a filter on which biotic particles can be separated for identification by Raman spectroscopy. Here the entire cross section of flow of the medium to be analyzed is preferably conducted through the filter, i.e., at first on the front side of the filter. The filter has open through pores that have a first diameter on a measuring surface of the filter (front side of the filter) which diameter is in the range from 0.1 to 15 μm, from 0.4 to 10 μm, or from 2 to 10 μm and the pore diameters taper down over the thickness of the filter in the direction of the filter surface located opposite the measuring surface, and the pore diameters on the filter surface (back side of the filter) opposite the measuring surface have a second diameter in the range of 5 to 75 percent, in particular 25 to 50 percent of the first diameter. The through pore conduits therefore taper from the front side of the filter to the back side of the filter. In a preferred embodiment the filter comprises a layer of gold and/or catcher molecules such as, for example, phage proteins on the measuring surface in order to achieve better selectivity and sensitivity as regards biotic particles. The catcher molecules can specifically retain, e.g., a certain type of biotic particles, e.g., bacteria.

Independently of the type of the filter, it can be provided with catcher molecules in order to retain only biotic particles in a purposeful manner whereas abiotic particles are removed from the filter, e.g., are washed off. In principle, a cascaded process can also be conceived in that different filters with different pore sizes are connected in series and therefore germs with different sizes are separated from each other.

The pore diameters on the measuring surface are preferably so large that a microorganism (e.g., a bacterium) can find space there. The openings of the through pores opposite the measuring surface should make possible the lowest possible resistance to the flowing out of the medium.

The filter is preferably constructed as a sieve, i.e., not a three-dimensional tissue but rather a perforated membrane. The measuring surface of the filter should be very level, the pore distribution on the filter should be as homogeneous as possible and the pore sizes and pore geometries should be substantially identical. On the one hand the filter should be very thin in order to make a high flowthrough rate possible but on the other hand be sufficiently robust mechanically. Furthermore, the filter should supply only a slight and/or a constant Raman background signal.

Suitable filters are micromechanical filters with a filter thickness in the range of 400 nm-10 μm, consisting, e.g., of silicon, metal, quartz, material coated with metal. The pore diameter is preferably 50 nm-5 μm. The pore distance is preferably also on the same order of magnitude. In order to be mechanically robust, the filter membrane can be applied loosely or fixed on a carrier frame.

When using metallic filters (Ag or Au) with a roughness of a few 100 nm the radiation with laser light can lead to the excitation of plasmon resonances. This brings about an advantageous reinforcement of the Raman spectra, which is accompanied by short-term measuring times, and an increase of the specificity and sensitivity by reinforced membrane information about the microorganisms. In addition to the Raman spectra, bright and dark field microscope data about the separated particles can additionally be detected.

Another preferred embodiment of the device in accordance with the invention is distinguished in that for the automatic localizing of biotic particles separated on the measuring surface of the filter a laser, a light-scattering laser as well as an evaluation unit are present, whereby the backscattered laser light can be evaluated for the presence of biotic particles by the evaluation unit, the laser has a variably adjustable focusing lens for the laser beam with which a laser spot with a variable diameter for scanning the measuring surface can be produced on the measuring surface of the filter, and a second control means is present that is designed and adjusted for controlling the automatic localizing of the separated biotic particles in such a manner that at first a rough scanning of the measuring surface with the first diameter d₁ of the laser spot is carried out and subsequently another scanning with a second diameter d₂ of the laser spot takes place in the areas of the measuring surface in which biotic particles were determined, whereby d₂<d₁, for a more precise localization of the biotic particles. Of course, the laser scanning of the measuring surface can be carried out multiple times in succession with diameters of the laser spot that become smaller in order to achieve an increasingly more precise resolution of the scanning in this manner.

Another preferred further development of the device in accordance with the invention is distinguished in that a differential pressure measuring system for determining a difference of the static pressure in the medium to be analyzed in the direction of flow before and after the measuring cell and/or a measuring system for determining a current volume throughput of the medium to be analyzed by the measuring cell is/are present, a second means is present with which the volume throughput through the measuring cell can be adjusted, and a third control means for controlling the second means is present, whereby the control of the second means takes place depending on the determined current volume throughput and/or of the determined current differential pressure in such a manner that a settable theoretical volume throughput of the medium to be analyzed through the measuring cell is maintained.

Other advantages, features and details result from the following description in which an exemplary embodiment is described. Described and/or graphically represented features form the subject matter of the invention alone or in any appropriate combination, if necessary also independently of the claims, and can in particular additionally also be subject matter of one or more separate applications. The same, similar and/or functionally equivalent parts are provided with the same reference numerals.

In the drawing:

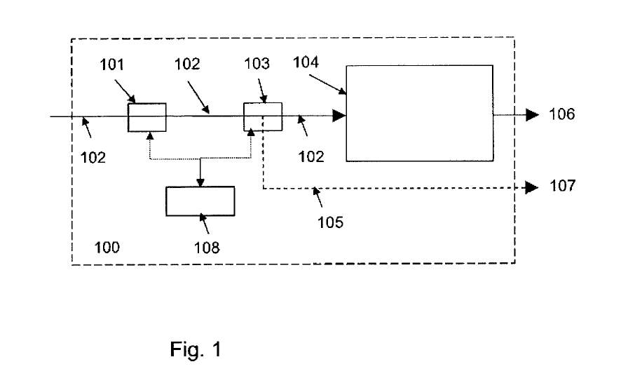

FIG. 1 shows a preferred embodiment of the device in accordance with the invention.

FIG. 1 shows a preferred embodiment of the device 100 in accordance with the invention for identifying biotic particles in ambient air potentially charged with biotic particles. It is assumed here that the device 100 draws in the ambient air by a suction device that is not shown. The device 100 comprises a measuring cell 104 through which the ambient air to be analyzed can flow and in which the identification of the biotic particles takes place by Raman spectroscopy, and comprises a feed 102 by which the medium to be analyzed is fed to the measuring cell 104. According to the invention the feed 102 comprises at least one sensor 101 with which the presence of biotic particles in the ambient air flowing through the feed 102 can be determined. Furthermore, the feed 102 comprises a controllable bypass valve 103 via which the ambient air to be analyzed can be fed selectively to the measuring cell 104 or to a bypass conduit 105. In the first instance the ambient air is conducted through the measuring cell 104 and biotic particles contained in it are identified by Raman spectroscopy. The exhaust air leaves the device via the opening 106 into the surroundings. In the second instance the ambient air is conducted via the bypass conduit 105 and the outlet opening 107 directly into the surroundings. Furthermore, the device 100 comprises a first control means 108 with which the bypass valve 103 can be controlled in such a manner that the ambient air to be analysed is only fed to the measuring cell 104 for the identification of the biotic particles if biotic particles had been previously recognized in the ambient air by the sensor 101.

1. A device to identify biotic particles in a medium, with a measuring cell through which the medium is enabled to flow and in which identification of the biotic particles takes place by Raman spectroscopy, and with a feed with which the medium is enabled to be fed to the measuring cell, wherein:
the feed comprises a sensor to detect presence of biotic particles in the medium flowing through the feed;
the feed comprises a controllable bypass valve connected downstream from the sensor in a direction of flow, the controllable bypass valve to selectively feed the medium the measuring cell or a bypass conduit; and
wherein a first control means is present for controlling the bypass valve in such a manner that the medium is only fed to the measuring cell to identify the biotic particles if the biotic particles were recognized by the sensor in the medium.

2. The device according to claim 1, wherein the sensor is an optical sensor to determine at least one optical quality of the medium determined.

3. The device according to claim 1, wherein the sensor is an optical sensor to determine a particle size or a particle density of particles present in the medium.

4. The device according to claim 1, wherein the feed between the bypass valve and the measuring cell or the measuring cell itself comprises a first means for inactivating biotic particles in the medium.

5. The device according to claim 4, wherein the first means for inactivating biotic particles comprises an electromagnetic radiation source or a particle radiation source.

6. The device according to claim 4, wherein the first means is designed and adjusted to emit a substance that inactivates biotic particles in the medium.

7. The device according to claim 1, wherein the medium is gaseous or liquid.

8. The device according claim 1, wherein the measuring cell comprises a filter to separate biotic particles for identification by Raman spectroscopy, the flow of the medium being conducted through the filter, at first on a front side of the filter, wherein the filter has through pores that have a first diameter on a measuring surface of the filter which first diameter is in the range from 0.1 μm to 15 μm, and pore diameters taper down over a thickness of the filter in a direction of a surface of the filter located opposite the measuring surface, and the pore diameters on a filter surface opposite the measuring surface have a second diameter in a range of 5 percent to 75 percent of the first diameter.

9. The device according to claim 8, wherein the filter has a gold layer or phage proteins on the measuring surface.

10. The device according to claim 1, wherein the measuring cell comprises a sensor means for detecting a form, or a size, or a nature of surface, or a color of biotic particles.

11. The device according to claim 8, wherein:
for the automatic localizing of biotic particles separated on the measuring surface of the filter a laser, a light-scattering laser as well as an evaluation unit are present, wherein backscattered laser light is evaluated for presence of biotic particles by the evaluation unit;
the laser has a variably adjustable focusing lens for a laser beam to produce a laser spot with a variable diameter on the measuring surface of the filter for scanning the measuring surface; and
a second control means is present that is designed and adjusted for controlling the automatic localizing of the separated biotic particles in such a manner that at first a rough scanning of the measuring surface with the first diameter d1 of the laser spot is carried out and subsequently another scanning with a second diameter d2 of the laser spot takes place in the areas of the measuring surface in which biotic particles were determined, wherein d2<d1, for a more precise localization of the biotic particles.

12. The device (100) according to claim 1, wherein:
a differential pressure measuring system for determining a difference of a static pressure in the medium in the direction of flow before and after the measuring cell or a measuring system for determining a current volume throughput of the medium by the measuring cell is present;
a second means is present to adjust the volume throughput through the measuring cell; and
a third control means for controlling the second means is present, control of the second means takes place depending on the determined current volume throughput or of the determined current differential pressure in such a manner that a settable theoretical volume throughput of the medium through the measuring cell is maintained.

13. The device of claim 2, wherein the at least one optical quality is fluorescence, absorption or transmission.

14. The device of claim 8, wherein the first diameter is in a range from 0.4 μm to 10 μm, or 2 μm to 10 μm.

15. The device of claim 8, wherein a second diameter in a range of 25 percent to 50 percent of the first diameter.
